(19) United States
(12) Patent Application Publication
(10) Pub. No.: US 2016/0371305 A1
(43) Pub. Date: Dec. 22, 2016

(54) METHOD, DEVICE AND APPARATUS FOR GENERATING PICTURE SEARCH LIBRARY, AND PICTURE SEARCH METHOD, DEVICE AND APPARATUS

(71) Applicant: BAIDU ONLINE NETWORK TECHNOLOGY (BEIJING) CO., LTD., Beijing (CN)

(72) Inventor: Duohao QIN, Beijing (CN)

(21) Appl. No.: 14/898,436

(22) PCT Filed: Dec. 18, 2014
(86) PCT No.: PCT/CN2014/094211

§ 371 Date: Dec. 14, 2015

(30) Foreign Application Priority Data
Aug. 1, 2014 (CN) 201410377461.0

(51) Int. Cl. G06F 17/30; G06K 9/62; G06K 9/00

(52) U.S. Cl. CPC G06F 17/30268; G06F 17/3028; G06F 17/30265; G06K 9/00288; G06K 9/6215; G06K 9/622; G06K 2009/00322

(57) ABSTRACT

Embodiments of the present disclosure provide a method, a device, and an apparatus for generating a picture search library, and a method, a device and an apparatus for searching a picture. The method for generating a picture search library includes: obtaining image data of a shooting object; generating an identifying picture according to the image data and identification information; and providing the identifying picture to the picture search library; in which, the identification information includes a shooting time and a shooting location of the image data. The method for searching a picture includes: searching a picture search library for a target identifying picture matched with a target picture; and providing the target identifying picture to a user, in which, the target identifying picture comprises image data and identification information, and the identification information includes a shooting time and a shooting location of the image data.

This application claims priority to and benefits of Chinese Patent Application Serial No. 201410377461.0, filed with the State Intellectual Property Office of P. R. China on Aug. 1, 2014, which is entitled as “Method and Apparatus For Generating Picture Search Library, Picture search method and Apparatus” and owed by BAIDU ONLINE NETWORK TECHNOLOGY (BEIJING) CO., LTD, the entire content of which is incorporated herein by reference.

### FIELD

The present disclosure relates to computer technology, more particularly to a method, a device, and an apparatus for generating a picture search library, and a picture search method, device and apparatus.

### BACKGROUND

As an increasing development of information on the internet, an increasing number of redundant information is in the internet, such that for the internet user, looking for information he needs on the internet is like looking for a needle in the ocean. An occurrence of a search engine brings a huge convenience for a search requirement of the users to some extent. The search engine, typically Baidu search (e.g. www.baidu.com), is a software system applied on the network, which collects and finds information with a certain strategy, and provides an Internet information search service for the users after processing and organizing the collected and found information.

As an increasing development of network technology, the search engine's users are no longer satisfied with text search, and many users wish to perform picture search via the search engine. The existing picture search methods are mainly based on comparing image features of a target picture with each picture included in a picture library, and providing a picture having a similarity greater than a preset similarity threshold to the user, in which, pictures in the picture library are obtained through capturing from each webpage by web-crawlers via the search engine.

However, as technology advances, people have higher requirement on the picture search technology, and traditional picture search technologies can no longer satisfy people's increasing requirement of personalized picture search.

### SUMMARY

Accordingly, a method, a device, and an apparatus for generating a picture search library, and a picture search method, device and apparatus are provided in embodiments of the present disclosure, so as to optimize existing picture search technology, such that the increasing requirements of personalized and convenient picture search can be satisfied.

According to a first aspect, embodiments of the present disclosure provide a method for generating a picture search library, including:

obtaining image data of a shooting object;

generating an identifying picture according to the image data and identification information; and

providing the identifying picture to the picture search library;

in which, the identification information comprises a shooting time and a shooting location of the image data.

According to a second aspect, embodiments of the present disclosure provide a picture search method, including:

searching a picture search library for a target identifying picture matched with a target picture; and

providing the target identifying picture to a user, in which, the target identifying picture comprises image data and identification information;

in which, the identification information comprises a shooting time and a shooting location of the image data.

According to a third aspect, embodiments of the present disclosure provide a device for generating a picture search library, including:

an image data obtaining unit, configured to obtain image data of a shooting object;

an identifying picture generating unit, configured to generate an identifying picture according to the image data and identification information; and

an identifying picture providing unit, configured to provide the identifying picture to the picture search library;

in which, the identification information comprises a shooting time and a shooting location of the image data.

According to a fourth aspect, embodiments of the present disclosure provide a picture search device, including:

a target identifying picture searching unit, configured to search a picture search library for a target identifying picture matched with a target picture; and

a target identifying picture providing unit, configured to provide the target identifying picture to a user, in which, the target identifying picture comprises image data and identification information;

in which, the identification information comprises a shooting time and a shooting location of the image data.

According to a fifth aspect, embodiments of the present disclosure provide an apparatus, including:

one or more processors;

a memory; and

one or more programs, in which the one or more programs are stored in the memory, and when executed by the one or more processors, causes the more one or more processors to perform following operations:

obtaining image data of a shooting object;

generating an identifying picture according to the image data and identification information; and

providing the identifying picture to the picture search library;

in which, the identification information comprises a shooting time and a shooting location of the image data.

According to a sixth aspect, embodiments of the present disclosure provide an apparatus, including:

one or more processors;

a memory; and

one or more programs, in which the one or more programs are stored in the memory, and when executed by the one or more processors, causes the one or more processors to perform following operations:

searching a picture search library for a target identifying picture matched with a target picture; and

providing the target identifying picture to a user, in which, the target identifying picture comprises image data and identification information;

in which, the identification information comprises a shooting time and a shooting location of the image data.

With embodiments in the present embodiment, image data of the shooting object is obtained; an identifying picture is generated by adding identification information to the image data; the identifying picture is sent to the picture search library; the picture search library is searched for finding a target identifying picture matched with a target picture; and the target identifying picture is provided to the user. According to the above technical solution, the existing picture search technology is optimized, sources and types of data the picture search library are enriched, and the increasing requirements of personalized and convenient picture search are satisfied.

### BRIEF DESCRIPTION OF THE DRAWINGS

FIG. 1 is a flow chart of a method for generating a picture search library according to a first embodiment of the present disclosure.

FIG. 2 is a schematic diagram of a human-computer interaction illustrating providing an identifying picture to a picture search library according to a first embodiment of the present disclosure.

FIG. 3 is a flow chart of a picture search method according to a second embodiment of the present disclosure.

FIG. 4 is a schematic diagram of a human-computer interaction illustrating searching for a picture via a search engine according to a second embodiment of the present disclosure.

FIG. 5 is a flow chart of a picture search method according to a third embodiment of the present disclosure.

FIG. 6 is a flow chart of a picture search method according to a fourth embodiment of the present disclosure.

FIG. 7 is a schematic diagram illustrating performing an ageing process on a face image in terms of different time intervals according to a fourth embodiment of the present disclosure.

FIG. 8 is a flow chart of a picture search method according to a fifth embodiment of the present disclosure.

FIG. 9 is a block diagram of a device for generating a picture search library according to a sixth embodiment of the present disclosure.

FIG. 10 is block diagram of a picture search device according to a seventh embodiment of the present disclosure.

FIG. 11 is a block diagram of a hardware structure of an apparatus according to a tenth embodiment of the present disclosure.

### DETAILED DESCRIPTION

Reference will be made in detail to embodiments of the present disclosure, so as to make objectives, technical solutions and advantages of the present disclosure clearer. It should be understood that, embodiments described herein are only used to explain the present disclosure, but not used to limit the present disclosure. In addition, it should be noted that, for sake of description, part of content related to the present disclosure is illustrated in the drawings, but not all the content.

### First Embodiment

FIG. 1 is a flow chart of a method for generating a picture search library according to the first embodiment of the present disclosure, in which the method may be performed by the device for generating a picture search library, and the device, which is generally integrated in a terminal device having a camera function and used in cooperation with a server where the photo search library is located, may be realized by hardware and/or software. The method in the present embodiment specifically includes steps as follows.

In step 110, image data of a shooting object is obtained.

In the present embodiment, the terminal device obtains the image data of the shooting object.

The terminal device may obtain the image data of the shooting object via a built-in or external photo device (e.g. a camera etc.).

In step 120, an identifying picture is generated according to the image data and identification information.

In the present embodiment, the identifying picture is generated by the terminal device according to the image data and identification information.

In the present embodiment, the identification information is used for facilitating identifying the picture, and preferably includes a shooting time and a shooting location of the image data.

The terminal device may obtain the identification information input manually via a preset interface, or may obtain the shooting location of the image data via a built-in GPS (Global Positioning System) sensor, and obtain a system time corresponding to a shooting moment of the image data as the shooting time of the image data.

In the present embodiment, the terminal device may add the identification information to the image data for generating the identifying picture, such that the identification information is displayed in the picture where the image data is; the terminal device may also generate the identifying picture by storing the identification information and the image data in way of one-to-one correspondence, such that the identification information may be displayed synchronously when displaying the picture including the image data.

It should be understood that, except for the shooting time and the shooting location of the image data, the identification information may further include other information, e.g. note information input by a user via the preset interface, which is not limited in the present disclosure.

In step 130, the identifying picture is provided to the picture search library.

In the present embodiment, the identifying picture is provided to the picture search library by the terminal device.

The terminal device may communicate with the server where the picture search library is located in a wired or wireless way, so as to provide the identifying picture to the picture search library.

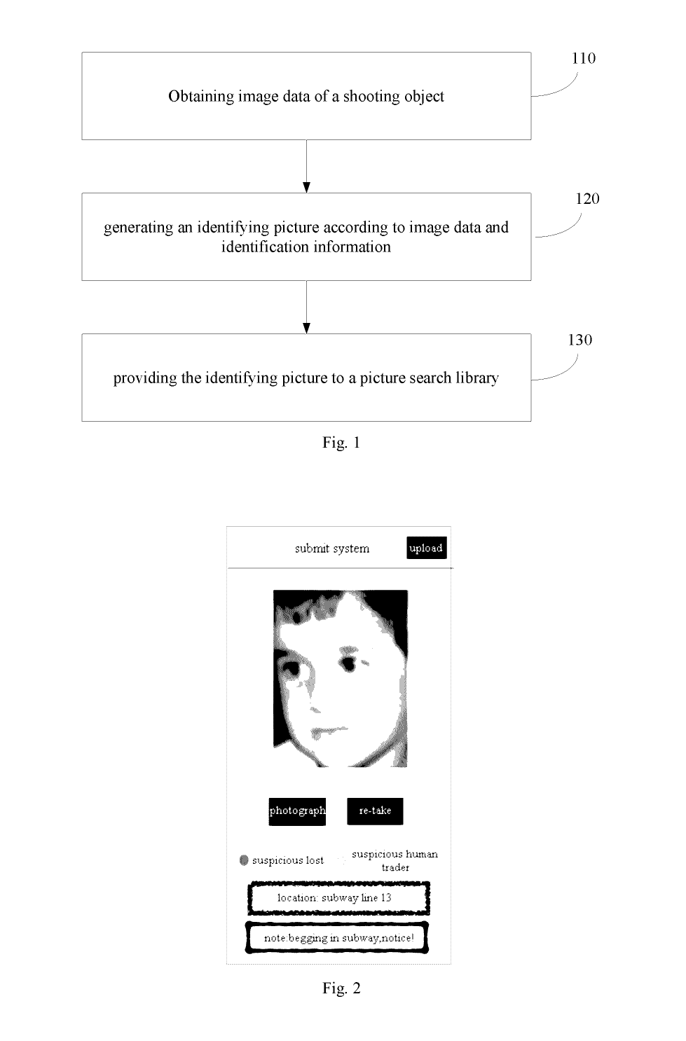

In an application scene of the present embodiment, when a person is suspected as a missing person at a place such as a street side, a subway station, or a railway station, people may take a photo of him via a camera on a mobile device. The mobile device may obtain position information (e.g. a specific subway line, or a specific road mark) via the built-in GPS sensor and record a specific time when the photo is taken. After taking the photo, the user may post other description information (e.g. accent) of the suspected missing person on a note. Then, the user may upload the photo and related information to the picture search library via the mobile device, in which the photo is used as a sample for searching for pictures of the missing person. FIG. 2 shows the human-computer interaction illustrating providing the identifying picture to the picture search library.

In another application scene of the present embodiment, the user may accidentally pick up or find an lost object or a missing animal, e.g. a cell phone, a bag or a pet dog, and when he hands the lost object or the missing animal to a lost and found office or a relevant department, the user may take a picture on the lost object or the missing animal, and upload an identifying picture to the picture search library after adding identification information, such that somebody who lost his object may search for the lost object conveniently.

With the embodiment of the present disclosure, by obtaining image data of a shooting object; generating an identifying picture by adding the image data and identification information; and providing the identifying picture to the picture search library, the existing picture search technology is optimized, sources and types of data in the picture search library are enriched, and the increasing requirements of personalized and convenient picture search are satisfied. Furthermore, pictures and picture information from various sources are provided for other users' picture search, and thus a hit rate and an efficiency of the picture search are indirectly improved.

Based on the above-described embodiments, the method further includes: sending a query instruction to the image search library, so as to query search state information corresponding to the identifying picture.

In the present embodiment, for a user who has sent an identifying picture to the picture search library, he may send the query instruction to the image search library using the terminal device, for querying search state information corresponding to the identifying picture, e.g. how many times the identifying picture is hit by search, and a process situation of the identifying picture (whether the lost object is found or whether the missing person is rescued).

### Second Embodiment

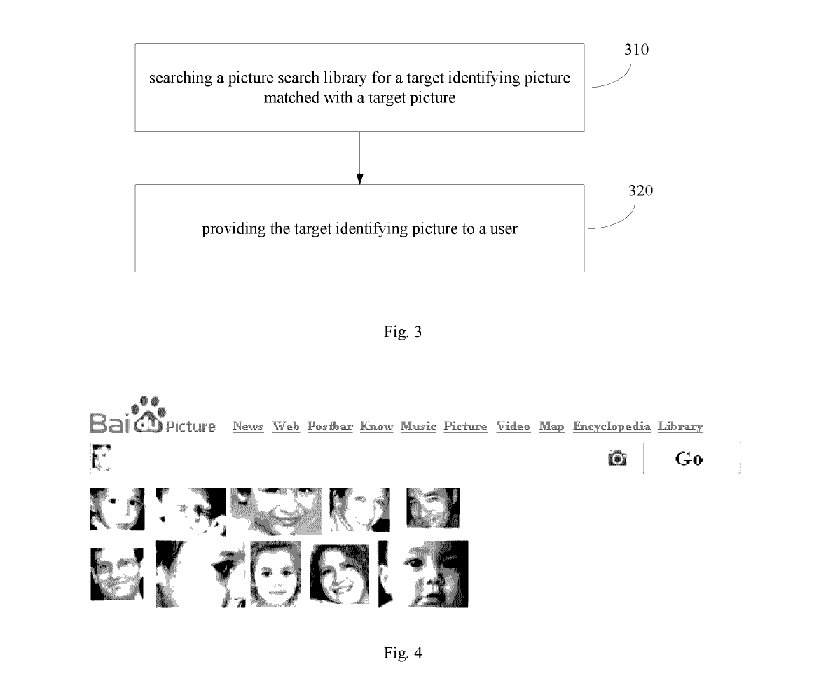

FIG. 3 is a flow chart of a picture search method according to the second embodiment of the present disclosure, in which the method may be performed by the picture search device, and the device, which is generally integrated in a picture search server storing a picture search library and used in cooperation with a client where the device for generating the picture search library, may be realized by hardware and/or software. The method in the present embodiment specifically includes steps as follows.

In step 310, a picture search library is searched for finding a target identifying picture matched with a target picture.

In the present embodiment, the picture search server searches for the target identifying picture matched with the target picture in the picture search library.

The identifying picture stored in the picture search library includes image data and identification information, and the identification information preferably includes a shooting time and a shooting location of the image data.

In the present embodiment, the target picture may be a query picture input to the picture search server by a user via a query interface provided by the picture search server.

The picture search server may directly match each identifying picture stored in the picture search library with the target picture, so as to obtain the target identifying picture. Or, the picture search server may search for the target identifying picture matched with the target picture among eligible identifying pictures according to query conditions input by the user (e.g. the shooting time and/or the shooting location). Or, the picture search server may first perform an image processing on the target picture, and then match the processed target picture with identifying pictures in the picture search library respectively. Or, the picture search server may first process the target picture and the identifying pictures in the picture search library respectively, and then match the processed target picture with the processed identifying picture. In the present embodiment, the search manner is not limited.

In step 320, the target identifying picture is provided to the user.

In the present embodiment, the target identifying picture is provided to the user by the picture search server.

FIG. 4 shows a human-computer interaction illustrating searching for a picture via a search engine. As shown in FIG. 4, the user may upload the target picture via an uploading interface (an input box of a search engine) provided by the search engine, and after searching the picture search library, the picture search server returns the matched identifying pictures to a search result display page of the search engine.

With embodiments of the present disclosure, by searching a picture search library for the target identifying picture matched with the target picture; and providing the target identifying picture to the user, the existing picture search technology is optimized, sources and types of data in the picture search library are enriched, and the increasing requirements of personalized and convenient picture search are satisfied. Furthermore, pictures and picture information from various sources are provided for other users' picture search, and thus a hit rate and an efficiency of the picture search are indirectly improved.

### Third Embodiment

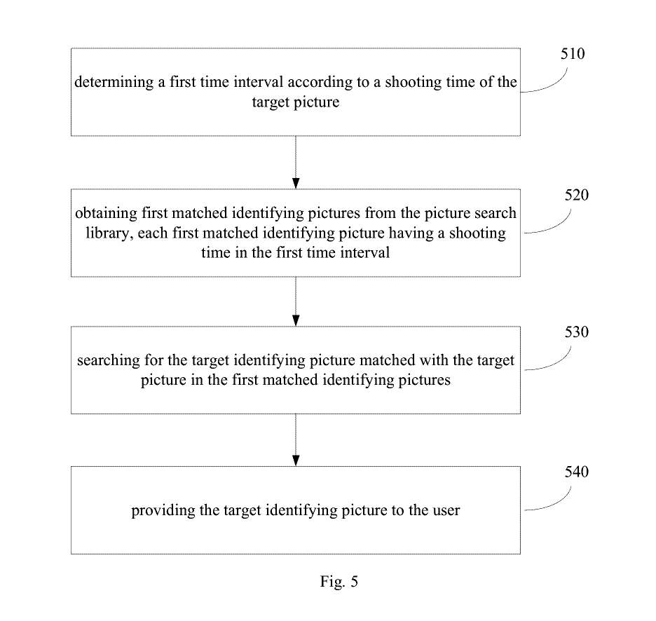

FIG. 5 is a flow chart of a picture search method according to a third embodiment of the present disclosure. The present disclosure is an optimization based on the above embodiment. Preferably, searching the picture search library for the target identifying picture matched with the target picture is optimized as follows: determining a first time interval according to a shooting time of the target picture; obtaining first matched identifying pictures from the picture search library, each first matched identifying picture having a shooting time within the first time interval; and searching for the target identifying picture matched with the target picture in the first matched identifying pictures.

Accordingly, the method in the present embodiment includes steps as follows.

In step 510, a first time interval is determined according to a shooting time of the target picture.

In an application scene of the present embodiment, the method may be used to help the user search for a lost person or a missing pet. Therefore, the timeliness is considered as a quite important point for picture search. For example, when the user wants to search for a lost person, the accuracy rate of picture search may be very low if the target picture is directly matched with all the pictures stored in the picture search library, since the appearance of the lost person greatly changes as time goes on.

In the present embodiment, the first time interval may be determined by the picture search server according to the shooting time of the target picture.

For example, if the user uploads an image of a face of a lost person as the target picture, he should enter the shooting time (e.g. 2013.5.4) of the face image at the same time, and then the picture search server may determine the suitable first time interval (e.g. 2012-2014) according to the shooting time of the target picture as a search time interval, such that the identifying pictures having the shooting time within the search time interval are matched with the target picture.

In the present embodiment, the size and the precision of the first time interval may be preset according to actual situations, which is not limited in the present disclosure.

In step 520, first matched identifying pictures are obtained from the picture search library, each first matched identifying picture having a shooting time within the first time interval.

In step 530, the target identifying picture matched with the target picture is obtained from the first matched identifying pictures.

In step 540, the target identifying picture is provided to the user.

In the present embodiment, considering that the appearance of a person or an object in the target picture will change as time goes on, only the identifying pictures satisfying the time interval where the shooting time of the target picture is are matched with the target picture, so as to ensure the matching effect as accurate as possible. However, if the target picture is shot a long time ago, the target picture cannot be compared with the identifying pictures stored recently in the picture data library, and thus the hit rate of search is reduced.

### Fourth Embodiment

FIG. 6 is a flow chart of a picture search method according to a fourth embodiment of the present disclosure. The present embodiment is an optimization based on the above embodiments, and preferably, in the present embodiment, the target picture is optimized as a face image.

Preferably, searching a picture search library for a target identifying picture matched with a target picture is optimized as: performing an ageing process on the face in the target picture according to the shooting time of the target picture, so as to obtain a first ageing picture corresponding to a second time interval; obtaining second matched identifying pictures from the picture search library, each second matched identifying picture having a shooting time in the second time interval; and searching for the target identifying picture matched with the first ageing picture in the second matched identifying pictures.

Preferably, the method further includes: publishing the target picture on a first public platform, if none of identifying pictures in the picture search library is matched with the target picture.

Accordingly, the method in the present embodiment includes steps as follows.

In step 610, an ageing process is performed on the face in the target picture according to the shooting time of the target picture, so as to obtain a first ageing picture corresponding to a second time interval.

In the present embodiment, considering that lots of lost people cannot be found after many years (e.g. a child, lost at 3 years old, and not found after more than 20 years), and the appearance of the lost people will change a lot as time goes on, the matching effect will be bad and the hit rate will be low, if the parents make the search in the picture search library by using the face picture of the child at 3 years old as the target picture. In order to solve the problem, in the present embodiment, the picture search server an ageing process is performed on the face in the target picture according to the shooting time of the target picture, so as to obtain the first ageing picture corresponding to the second time interval.

For example, when the user uploads a face image of a 3-year-old lost child (shot at 1997) as the target picture, the picture search server may set an age limit according to the current system time, for example, ageing 17 years (2014 minus 1997), and then perform the ageing process on the face in the target picture for generating the first ageing picture corresponding to the second time interval, e.g. corresponding to 2013-2015.

Of course, it should be understood that, a range and an accuracy of the second time interval may be preset according to actual situations, which is not limited in the present disclosure.

In the present embodiment, the ageing process performed on the face in the target picture may be realized by a prototype based face ageing algorithm, a face shape based face ageing algorithm, or a wavelet based face ageing algorithm, which shall not be construed to limit the present disclosure.

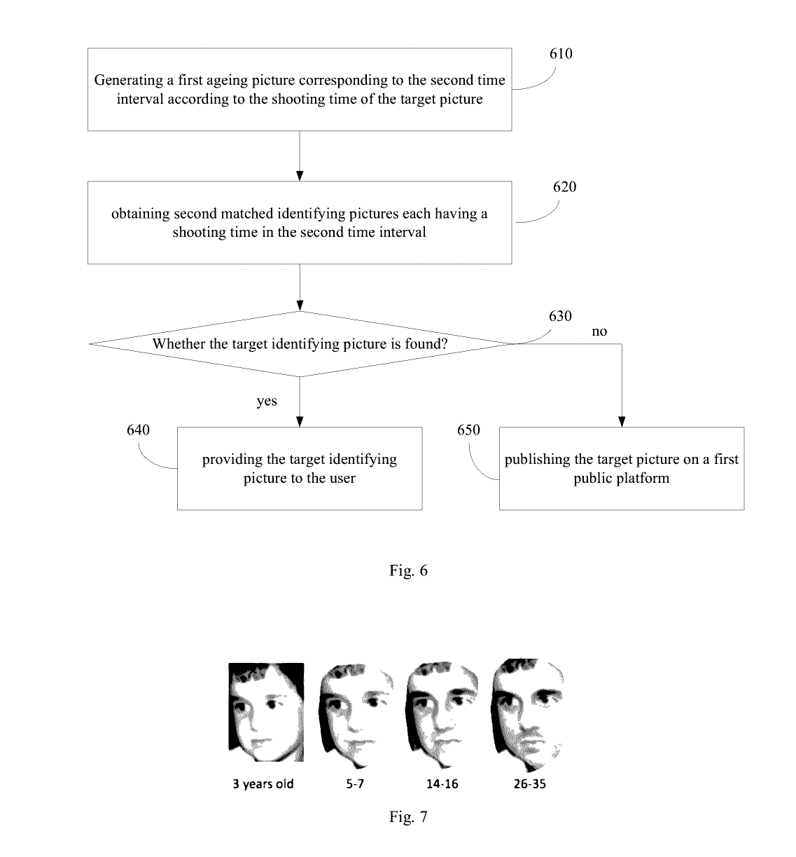

FIG. 7 shows a schematic diagram of an ageing process on an image of face according to different time intervals.

In a preferred implementation of the present embodiment, in order to improve the accuracy of the first ageing picture, multiple target picture may be bulk uploaded for enhancing the prediction accuracy of the ageing process, or pictures of close relatives may also be uploaded for facilitating prediction, which shall not be construed to limit the present disclosure.

In step 620, second matched identifying pictures are obtained from the picture search library, each second matched identifying picture having a shooting time in the second time interval.

In step 630, it is determined whether the target identifying picture matched with the first ageing picture is found in the second matched identifying pictures, if yes, step 640 is executed, and if no, step 650 is executed.

In step 640, the target identifying picture is provided to the user.

In step 650, the target picture is published on the first public platform.

In the present embodiment, the picture search server publishes the target picture on the first public platform, if it determines that none of identifying pictures in the picture search library is matched with the target picture. Such a configuration has an advantage that, if the user does not find the target identifying picture in the picture search library, the picture search server may publish the target picture of a lost person, an object or an animal which the user wishes to find on a public platform, such that more internet users may notice the target picture, thus enhancing the probability of finding the target identifying picture.

In the present embodiment, the first public platform may be a public platform which may be visited by many internet users, like a forum or a post bar.

With the embodiment of the present disclosure, by performing the ageing process on the face in the target picture, and matching the processed target picture with the identifying pictures in the picture search library, the existing picture search technology is optimized, and on the basis of ensuring the accuracy of the search, the problem that the user cannot compare the target picture with identifying pictures stored recently in the picture data library may be solved, and the hit rate of search is further improved.

### Fifth Embodiment

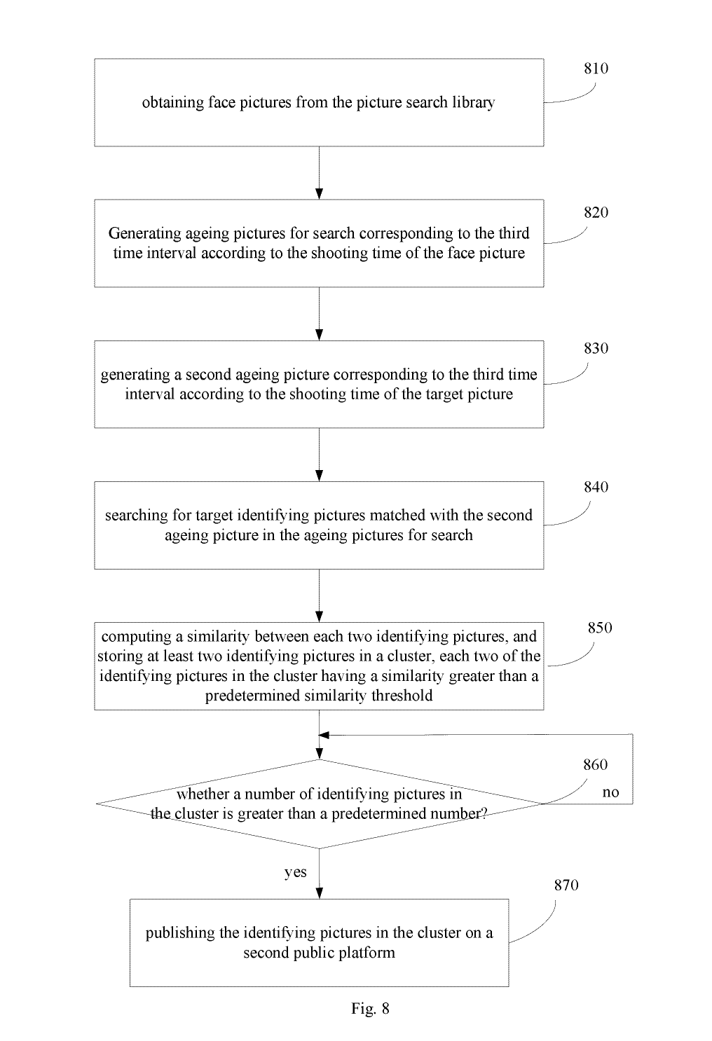

FIG. 8 is a flow chart of a picture search method according to a fifth embodiment of the present disclosure. The present embodiment is an optimization based on the above embodiments, and preferably, in this embodiment, the target picture is optimized as a face image.

Preferably, the method further includes: obtaining face pictures from the picture search library; performing an ageing process on a face in each face picture according to the shooting time of the face picture, so as to obtain ageing pictures for search corresponding to a third time interval.

Preferably, searching the picture search library for the target identifying picture matched with the target picture is optimized as: performing the ageing process on the face in the target picture according to the shooting time of the target picture, so as to obtain a second ageing picture corresponding to the third time interval; and searching for the target identifying picture matched with the second ageing picture in the ageing pictures for search.

Preferably, the method further includes: computing a similarity between each two identifying pictures in the picture search library, and storing at least two identifying pictures into a cluster, each two of at least two identifying pictures having a similarity greater than a preset similarity threshold; and publishing the identifying pictures in the cluster on a second public platform, if a number of the identifying pictures in the cluster is greater than a preset number threshold.

Accordingly, the method in the present embodiment includes steps as follows.

In step 810, face pictures are obtained from the picture search library.

In step 820, an ageing process is performed on a face in each face picture according to the shooting time of the face picture, so as to obtain ageing pictures for search corresponding to a third time interval.

In the present embodiment, in order to improve a picture search range in the picture search process, the picture search server performs the ageing process on all the face pictures according to the shooting time of the face picture, so as to obtain ageing pictures for search corresponding to the third time interval.

The picture search server may perform the ageing process on the face pictures stored in the picture search library every predetermined time, for example, every one year, every 2 years, or every 5 years.

For example, when the system time reaches 2017, the picture search server may perform the ageing process on all the face pictures in the picture search server with the shooting time before 2017, so as to obtain ageing pictures for search corresponding to the third time interval, e.g. corresponding to 2017-2018.

Of course, it should be understood that, a range and an accuracy of the third time interval may be preset according to actual situations, which shall not be construed to limit the present disclosure.

In step 830, the ageing process is performed on the face in the target picture according to the shooting time of the target picture, so as to obtain a second ageing picture corresponding to the third time interval.

In step 840, the target identifying picture matched with the second ageing picture is obtained from the ageing pictures for search.

In step 850, a similarity between each two identifying pictures in the picture search library is computed, and at least two identifying pictures are stored into a cluster, each two of at least two identifying pictures having a similarity greater than a preset similarity threshold.

In the present embodiment, considering an application scene in which multiple terminal users upload multiple pictures of a certain suspicious lost person, each picture being provided to the picture search library as the identifying picture, the similarity between each two identifying pictures in the picture search library may be computed for detecting this action, and the identifying pictures in one cluster may be published on the second public platform if the number of the identifying pictures in the cluster is greater than the preset number threshold, so as to attract attention from more people. Such a configuration has an advantage of further enhancing the probability of finding the suspicious lost person.

In step 860, it is determined whether the number of the identifying pictures in the cluster is greater than the preset number threshold, if yes, step 870 is executed, and if no, step 860 is returned to.

In step 870, the identifying pictures in the cluster are published on the second public platform.

In the present embodiment, the second public platform may be a public platform which may be visited by many internet users, like a forum or a post bar. The second public platform may be identical with or different from the first public platform, which shall not be construed to limit the present disclosure.

With the embodiment of the present disclosure, by performing the ageing process on the face in the target picture and performing the ageing process on the identifying pictures in the picture search library, and then comparing the processed target picture with the processed identifying pictures, the existing picture search technology is optimized, and on the basis of ensuring the search accuracy, the problem that the user cannot compare the target picture with the identifying pictures stored recently in the picture search library may be solved, and the picture search range and the hit rate of the search are further improved.

### Sixth Embodiment

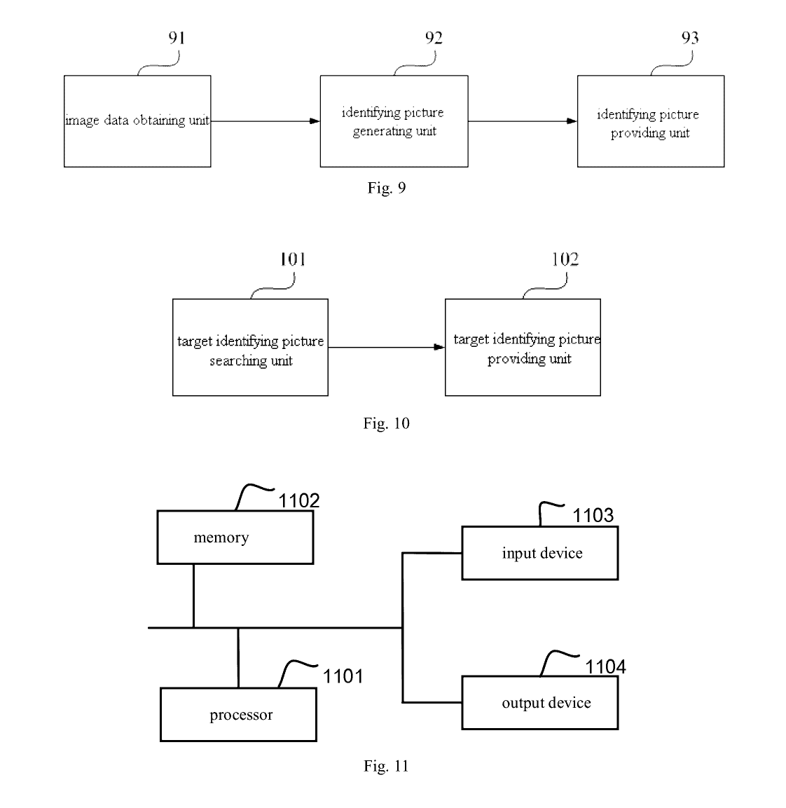

FIG. 9 shows a block diagram of a device for generating a picture search library according to a sixth embodiment of the present disclosure. As shown in FIG. 9, the device includes an image data obtaining unit 91, an identifying picture generating unit 92 and an identifying picture providing unit 93.

The image data obtaining unit 91 is configured to obtain image data of a shooting object. The identifying picture generating unit 92 is configured to generate an identifying picture according to the image data and identification information.

The identifying picture providing unit 93 is configured to provide the identifying picture to the picture search library, in which, the identification information includes a shooting time and a shooting location of the image data.

With the embodiment of the present disclosure, by obtaining image data of a shooting object; generating an identifying picture by adding identification information to the image data; and providing the identifying picture to the picture search library, the existing picture search technology is optimized, sources and types of data in the picture search library are enriched, and the increasing requirements of personalized and convenient picture search are satisfied. Moreover, pictures and picture information from various sources are provided for other users' picture search, and thus a hit rate and an efficiency of the picture search are indirectly improved.

The device for generating a picture search library provided in the present disclosure may be configured to perform the method for generating a picture search library provided in any embodiment of the present disclosure, having the corresponding function module and realizing the same beneficial effects.

### Seventh Embodiment

FIG. 10 shows a block diagram of a picture search device according to a seventh embodiment of the present disclosure. As shown in FIG. 10, the device includes a target identifying picture searching unit 101 and a target identifying picture providing unit 102.

The target identifying picture searching unit 101 is configured to search a picture search library for a target identifying picture matched with a target picture.

The target identifying picture providing unit 102 is configured to provide the target identifying picture to a user, in which, the target identifying picture includes image data and identification information, and the identification information includes a shooting time and a shooting location of the image data.

With embodiments of the present disclosure, by searching a picture search library for the target identifying picture matched with the target picture; and providing the target identifying picture to the user, the existing picture search technology is optimized, sources and types of data in the picture search library are enriched, and the increasing requirements of personalized and convenient picture search are satisfied. Furthermore, pictures and picture information from various sources are provided for other users' picture search, and thus a hit rate and an efficiency of the picture search are indirectly improved.

Based on the above-described embodiments, the target identifying picture searching unit 101 is specifically configured to:

determine a first time interval according to a shooting time of the target picture; obtain first matched identifying pictures from the picture search library, each first matched identifying picture having a shooting time within the first time interval; and search for the target identifying picture matched with the target picture in the first matched identifying pictures.

Based on the above-described embodiments, the target picture may include an image of a face.

The target identifying picture searching unit 101 may be specifically configured to: perform an ageing process on the face in the target picture according to the shooting time of the target picture, so as to obtain a first ageing picture corresponding to a second time interval; obtain second matched identifying pictures from the picture search library, each second matched identifying picture having a shooting time in the second time interval; and search for the target identifying picture matched with the first ageing picture in the second matched identifying pictures.

Based on the above-described embodiments, the target picture includes the face image; and the device further includes an ageing image generating unit, configured to: obtain face pictures in the picture search library; and perform an ageing process on the a face in each face picture according to the shooting time of the face picture, so as to obtain ageing pictures for search corresponding to a third time interval;

The target identifying picture searching unit may be specifically configured to: perform the ageing process on a face in the target picture according to the shooting time of the target picture, so as to obtain a second ageing picture corresponding to the third time interval; and search for the target identifying picture matched with the second ageing picture in the ageing pictures for search.

Based on the above-described embodiments, the device may further include a target picture publishing unit configured to publish the target picture on a first public platform, if none of identifying pictures in the picture search library is matched with the target picture.

Based on the above-described embodiments, the device may further include a cluster image publishing unit configured to: compute a similarity between each two identifying pictures in the picture search library, and store at least two identifying pictures into a cluster, each two of at least two identifying pictures having a similarity greater than a preset similarity threshold; and publish the identifying pictures in the cluster on a second public platform, if a number of the identifying pictures in the cluster is greater than a preset number threshold.

The picture search device provided in the present disclosure may be configured to perform the picture search method provided in any embodiment of the present disclosure, having the corresponding function module and realizing the same beneficial effects.

### Eighth Embodiment

Embodiments of the present disclosure also provide a non-volatile computer storage medium having stored therein one or more programs that, and when executed by an apparatus, causes the apparatus to perform following operations:

obtaining image data of a shooting object;

generating an identifying picture according to the image data and identification information; and

providing the identifying picture to the picture search library;

in which, the identification information includes a shooting time and a shooting location of the image data.

When the storage medium is executed by the apparatus for performing the above-described operations, the apparatus preferably further perform following operation:

sending a query instruction to the image search library, for querying search state information corresponding to the identifying picture.

### Ninth Embodiment

Embodiments of the present disclosure also provide a non-volatile computer storage medium having stored therein one or more programs that, when executed by an apparatus, causes the apparatus to perform following operations:

searching a picture search library for a target identifying picture matched with a target picture; and

providing the target identifying picture to a user, in which, the target identifying picture includes image data and identification information;

in which, the identification information includes a shooting time and a shooting location of the image data.

When the above storage medium is executed by the apparatus for performing the above-described operations, preferably, searching the picture search library for the target identifying picture matched with the target picture includes:

determining a first time interval according to a shooting time of the target picture;

obtaining first matched identifying pictures from the picture search library, each first matched identifying picture having a shooting time within the first time interval; and

searching for the target identifying picture matched with the target picture in the first matched identifying pictures.

Further, the target picture includes an image of a face; and searching the picture search library for the target identifying picture matched with the target picture includes:

performing an ageing process on the face in the target picture according to the shooting time of the target picture, so as to obtain a first ageing picture corresponding to a second time interval;

obtaining second matched identifying pictures from the picture search library, each second matched identifying picture having a shooting time in the second time interval; and

searching for the target identifying picture matched with the first ageing picture in the second matched identifying pictures.

Further, the target picture includes a face image, and the method further includes:

obtaining face pictures in the picture search library; and

performing an ageing process on a face in each face picture according to the shooting time of the face picture, so as to obtain ageing pictures for search corresponding to a third time interval;

searching the picture search library for the target identifying picture matched with the target picture includes:

performing the ageing process on the face in the target picture according to the shooting time of the target picture, so as to obtain a second ageing picture corresponding to the third time interval; and

searching for the target identifying picture matched with the second ageing picture in the ageing pictures for search.

Further, the operations further include:

publishing the target picture on a first public platform, if none of identifying pictures in the picture search library is matched with the target picture.

Further, the operations further include:

computing a similarity between each two identifying pictures in the picture search library, and storing at least two identifying pictures into a cluster, each two of at least two identifying pictures having a similarity greater than a preset similarity threshold; and

publishing the identifying pictures in the cluster on a second public platform, if a number of the identifying pictures in the cluster is greater than a preset number threshold.

### Tenth Embodiment

Referring to FIG. 11, embodiments of the present disclosure provide a hardware structure of an apparatus. The apparatus includes a processor 1101, a memory 1102, an input device 1103, and an output device 1104; in a terminal device. There may be one or more processors in the terminal apparatus. In FIG. 11, one processor 1101 is illustrated as an example. In the apparatus, the processor 1101, the memory 1102, the input device 1103 and the output device 1104 may be connected via a bus or other connection ways. In FIG. 11, the bus connection is illustrated as an example.

As a computer readable storage medium, the memory 1102 may be used to store software programs, computer executable programs and modules, such as program instructions/units (e.g. the image data obtaining unit 91, the identifying picture generating unit 92 and the identifying picture providing unit 93 in the device for generating a picture search library, as shown in FIG. 9) corresponding to the method for generating a picture search library in embodiments of the present disclosure; or program instructions/units (e.g. the target identifying picture searching unit 101 and the target identifying picture providing unit 102 in the picture search device, as shown in FIG. 10) corresponding to the picture search method. The processor 1101 performs various function applications and data processing in the terminal device by running software programs, instructions and modules stored in the memory 1102, so as to realize the method for generating a picture search library and the picture search method in above-described method embodiments.

The memory 1102 may include a program memory area and a data memory area, in which, the program memory area may store an operating system, and at least one application programs required by functions, and the data memory area may store data built during using the terminal device. In addition, the memory 1102 may include a high-speed random access memory, and may also include a non-volatile memory, e.g. at least one disk storage device, a flash device, or other non-volatile solid memory devices. In some embodiments, the memory 1102 may further include memories disposed remote from the processor 1101, and these remote memories may be connected to a server via a network. Examples of the network include, but not limited to an internet, an intranet, a local area network, a mobile communication network and a combination thereof.

The input device 1103 may be configured to receive input numbers or character information, and generate key signal input related to a terminal user setting and function control. The output device 1104 may include a display device such as a display screen.

In other words, the terminal device includes:

one or more processors;

a memory; and

one or more programs, in which the one or more programs are stored in the memory, and when executed by the one or more processors, causes the one or more processors to perform following operations:

obtaining image data of a shooting object;

generating an identifying picture according to the image data and identification information; and

providing the identifying picture to the picture search library;

in which, the identification information includes a shooting time and a shooting location of the image data.

Further, the operations include:

sending a query instruction to the image search library, so as to query search state information corresponding to the identifying picture.

Alternatively, the one or more programs are stored in the memory, and when executed by the one or more processors, cause the one or more processors to perform following operations:

searching a picture search library for a target identifying picture matched with a target picture; and

providing the target identifying picture to a user, in which, the target identifying picture comprises image data and identification information;

in which, the identification information includes a shooting time and a shooting location of the image data.

Further, searching the picture search library for the target identifying picture matched with the target picture includes:

determining a first time interval according to a shooting time of the target picture;

obtaining first matched identifying pictures from the picture search library, each first matched identifying picture having a shooting time within the first time interval; and

searching for the target identifying picture matched with the target picture in the first matched identifying pictures.

Further, the target picture includes an image of a face; and searching the picture search library for the target identifying picture matched with the target picture includes:

performing an ageing process on the face in the target picture according to the shooting time of the target picture, so as to obtain a first ageing picture corresponding to a second time interval;

obtaining second matched identifying pictures from the picture search library, each second matched identifying picture having a shooting time in the second time interval; and

searching for the target identifying picture matched with the first ageing picture in the second matched identifying pictures.

Further, the target picture includes a face image, and the method further includes: obtaining face pictures in the picture search library; and

performing an ageing process on a face in each face picture according to the shooting time of the face picture, so as to obtain ageing pictures for search corresponding to a third time interval;

searching the picture search library for the target identifying picture matched with the target picture includes:

performing the ageing process on the face in the target picture according to the shooting time of the target picture, so as to obtain a second ageing picture corresponding to the third time interval; and

searching for the target identifying picture matched with the second ageing picture in the ageing pictures for search.

Further, the method further includes:

publishing the target picture on a first public platform, if none of identifying pictures in the picture search library is matched with the target picture.

Further, the method further includes:

computing a similarity between each two identifying pictures in the picture search library, and storing at least two identifying pictures into a cluster, each two of at least two identifying pictures having a similarity greater than a preset similarity threshold; and

publishing the identifying pictures in the cluster on a second public platform, if a number of the identifying pictures in the cluster is greater than a preset number threshold.

From the above description on implementations, it can be understood by those skilled in the art that, the present disclosure may be realized by software and necessary universal hardware, or may be realized by hardware. In many cases, the present disclosure is preferably realized by software and necessary universal hardware. Based on such a understanding, the essence of technical solutions in the present disclosure or part making contributions to the related art may be embodied by software product. The software product may be stored in a computer readable storage medium, such as a floppy disk, a read only memory (ROM), a random access memory (RAM), a flash, a hard disk or an optical disk, and include several instructions for causing a computer device (may be a personal computer, a server, or a network device) to execute the method in various embodiments of the present disclosure.

It should be noted that, in the above device for generating a picture search library and the picture search device, respective units and modules are configured according to function logic. However, the units and modules may not be configured as described above, as long as they can realize corresponding function. In addition, specific names of respective function units are used for distinguishing, which shall not be construed to limit the present disclosure.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure. Thus, the scope of the present disclosure is limited by the appending claims.

1. A method for generating a picture search library, comprising:
obtaining image data of a shooting object;
generating an identifying picture according to the image data and identification information; and
providing the identifying picture to the picture search library;
wherein, the identification information comprises a shooting time and a shooting location of the image data.

2. The method according to claim 1, further comprising:
sending a query instruction to the image search library, so as to query search state information corresponding to the identifying picture.

3. A picture search method, comprising:
searching a picture search library for a target identifying picture matched with a target picture; and
providing the target identifying picture to a user, wherein, the target identifying picture comprises image data and identification information;
wherein, the identification information comprises a shooting time and a shooting location of the image data.

4. The method according to claim 3, wherein, searching the picture search library for the target identifying picture matched with the target picture comprises:
determining a first time interval according to a shooting time of the target picture;
obtaining first matched identifying pictures from the picture search library, each first matched identifying picture having a shooting time within the first time interval; and
searching for the target identifying picture matched with the target picture in the first matched identifying pictures.

5. The method according to claim 3, wherein, the target picture comprises an image of a face; and
searching the picture search library for the target identifying picture matched with the target picture comprises:
performing an ageing process on the face in the target picture according to the shooting time of the target picture, so as to obtain a first ageing picture corresponding to a second time interval;
obtaining second matched identifying pictures from the picture search library, each second matched identifying picture having a shooting time in the second time interval; and
searching for the target identifying picture matched with the first ageing picture in the second matched identifying pictures.

6. The method according to claim 3, wherein, the target picture comprises a face image, and the method further comprises:
obtaining face pictures in the picture search library; and
performing an ageing process on a face in each face picture according to the shooting time of the face picture, so as to obtain ageing pictures for search corresponding to a third time interval;
searching the picture search library for the target identifying picture matched with the target picture comprises:
performing the ageing process on the face in the target picture according to the shooting time of the target picture, so as to obtain a second ageing picture corresponding to the third time interval; and
searching for the target identifying picture matched with the second ageing picture in the ageing pictures for search.

7. The method according to claim 3, further comprising:
publishing the target picture on a first public platform, if none of identifying pictures in the picture search library is matched with the target picture.

8. The method according to claim 3, further comprising:
computing a similarity between each two identifying pictures in the picture search library, and storing at least two identifying pictures into a cluster, each two of at least two identifying pictures having a similarity greater than a preset similarity threshold; and
publishing the identifying pictures in the cluster on a second public platform, if a number of the identifying pictures in the cluster is greater than a preset number threshold.

9. (canceled)

10. A picture search device, comprising:
one or more processors;
a memory;
one or more programs, stored in the memory, and when executed by the one or more processors, causes the one or more processors to be configured to:
search a picture search library for a target identifying picture matched with a target picture; and
provide the target identifying picture to a user, wherein, the target identifying picture comprises image data and identification information;
wherein, the identification information comprises a shooting time and a shooting location of the image data.

11. The device according to claim 10, wherein, the one or more processors are configured to:
determine a first time interval according to a shooting time of the target picture;
obtain first matched identifying pictures from the picture search library, each first matched identifying picture having a shooting time within the first time interval; and
search for the target identifying picture matched with the target picture in the first matched identifying pictures.

12. The device according to claim 10, wherein, the target picture comprises an image of a face; and
wherein the one or more processors are configured to:
perform an ageing process on the face in the target picture according to the shooting time of the target picture, so as to obtain a first ageing picture corresponding to a second time interval;
obtain second matched identifying pictures from the picture search library, each second matched identifying picture having a shooting time in the second time interval; and
search for the target identifying picture matched with the first ageing picture in the second matched identifying pictures.

13. The device according to claim 10, wherein, the target picture comprises a face image; and
wherein the one or more processors are configured to:
obtain face pictures in the picture search library; and
perform an ageing process on a face in each face picture according to the shooting time of the face picture, so as to obtain ageing pictures for search corresponding to a third time interval;
perform the ageing process on a face in the target picture according to the shooting time of the target picture, so as to obtain a second ageing picture corresponding to the third time interval; and
search for the target identifying picture matched with the second ageing picture in the ageing pictures for search.

14. The device according to claim 10, wherein the one or more processors are further configured to:
publish the target picture on a first public platform, if none of identifying pictures in the picture search library is matched with the target picture.

15. The device according to claim 10, wherein the one or more processors are further configured to:
compute a similarity between each two identifying pictures in the picture search library, and store at least two identifying pictures into a cluster, each two of at least two identifying pictures having a similarity greater than a preset similarity threshold; and
publish the identifying pictures in the cluster on a second public platform, if a number of the identifying pictures in the cluster is greater than a preset number threshold.

16-17. (canceled)
